(19) United States
(12) Patent Application Publication
(10) Pub. No.: US 2024/0190264 A1
(43) Pub. Date: Jun. 13, 2024

(54) CONTROL DEVICE FOR VEHICLE

(71) Applicant: TOYOTA JIDOSHA KABUSHIKI KAISHA, Toyota-shi Aichi-ken (JP)

(72) Inventors: Yuki KAWASAKI, Toyota-shi Aichi-ken (JP); Tomoharu Maeda, Toyota-shi Aichi-ken (JP)

(73) Assignee: TOYOTA JIDOSHA KABUSHIKI KAISHA, Toyota-shi Aichi-ken (JP)

(21) Appl. No.: 18/380,227

(22) Filed: Oct. 16, 2023

(30) Foreign Application Priority Data
Dec. 8, 2022 (JP) 2022-196617

(51) Int. Cl. B60L 15/20

(52) U.S. Cl. CPC B60L 15/2045; B60L 50/60; B60L 2240/645

(57) ABSTRACT

A control device for a vehicle is configured to control the vehicle configured to perform an electric traveling using one or more electric motors driven by electric power from a battery. The control device includes a processor. The processor is configured to execute a calculation process of calculating an energy consumed by the electric traveling in a section from a first point to a second point of a planned travel route of the vehicle. In the calculation process, the processor is configured to: estimate whether or not a travel load of the section is high, based on road type of the section; and correct a basic value of the energy consumed, based on a correction efficient that differs depending on whether or not the travel load of the section is high.

### CROSS-REFERENCES TO RELATED APPLICATION

The present disclosure claims priority under 35 U.S.C. § 119 to Japanese Patent Application No. 2022-196617, filed on Dec. 8, 2022, which is incorporated herein by reference in its entirety.

### TECHNICAL FIELD

The present disclosure relates to a control device for a vehicle.

### BACKGROUND

JP 5780354 B discloses a vehicle control device. The vehicle control device is configured to calculate travel load information of a route to a destination. The travel load information is calculated for each section of the route, for example.

### SUMMARY

In a vehicle that performs electric traveling using an electric motor driven by electric power from a battery, when energy consumed by the electric traveling in a section is calculated, accurate calculation of the consumed energy in consideration of a difference in traveling scenes is desired.

The present disclosure has been made in view of the problem described above, and an object thereof is to provide a control device for a vehicle that can accurately calculate an energy consumed by electric traveling in consideration of a difference in traveling scenes.

A control device for a vehicle according to a first aspect of the present disclosure is configured to control the vehicle configured to perform an electric traveling using one or more electric motors driven by electric power from a battery. The control device includes a processor. The processor is configured to execute a calculation process of calculating an energy consumed by the electric traveling in a section from a first point to a second point of a planned travel route of the vehicle. In the calculation process, the processor is configured to: estimate whether or not a travel load of the section is high, based on road type of the section; and correct a basic value of the energy consumed, based on a correction efficient that differs depending on whether or not the travel load of the section is high.

A control device for a vehicle according to a second aspect of the present disclosure is configured to control the vehicle configured to perform an electric traveling using one or more electric motors driven by electric power from a battery. The control device includes a processor. The processor is configured to execute a calculation process of calculating an energy consumed by the electric traveling in a section from a first point to a second point of a planned travel route of the vehicle. In the calculation process, the processor is configured to: estimate whether or not a travel load of the section is high, based on magnitude of a basic value of the energy consumed in the section; and correct the basic value, based on a correction efficient that differs depending on whether or not the travel load of the section is high.

A control device for a vehicle according to a third aspect of the present disclosure is configured to control the vehicle configured to perform an electric traveling using one or more electric motors driven by electric power from a battery. The control device includes a processor. The processor is configured to execute a calculation process of calculating an energy consumed by the electric traveling in a section from a first point to a second point of a planned travel route of the vehicle. In the calculation process, the processor is configured to: estimate whether or not a travel load of the section is high, based on vehicle peed of the section; and correct the basic value, based on a correction efficient that differs depending on whether or not the travel load of the section is high.

Each of the first to third aspects of the present disclosure makes it possible to accurately calculate an energy consumed by the electric traveling in consideration of a difference in traveling scenes.

### BRIEF DESCRIPTION OF DRAWINGS

FIG. 1 is a diagram schematically showing a configuration of a vehicle according to an embodiment;

FIG. 2 is a flowchart illustrating a procedure of a calculation process according to a Calculation Example 1 of the embodiment;

FIG. 3 is a graph showing a map of efficiency nm of an electric motor 14 shown in FIG. 1;

FIG. 4 is a flowchart illustrating a procedure of a calculation process according to a Calculation Example 2 of the embodiment; and

FIG. 5 is a flowchart illustrating a procedure of a calculation process according to a Calculation Example 3 of the embodiment.

### DETAILED DESCRIPTION

Embodiments of the present disclosure will be described with reference to the accompanying drawings.

### 1. Configuration Example of Vehicle

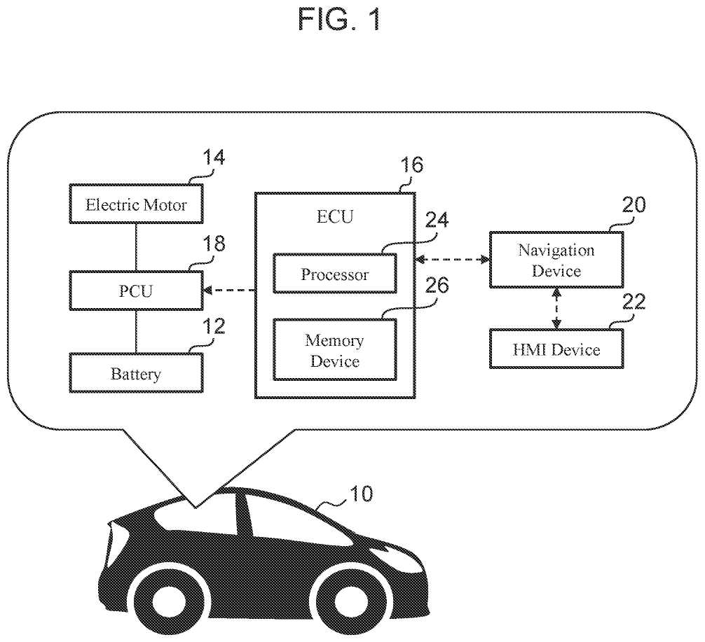

FIG. 1 is a diagram schematically showing a configuration of a vehicle 10 according to an embodiment. The vehicle 10 is a battery electric vehicle (BEV) and includes a battery 12 and one or more electric motors (hereinafter, simply referred to as an “electric motor”) 14. The vehicle 10 can perform electric traveling (i.e., EV traveling) using the electric motor 14 driven by electric power from the battery 12. The “vehicle” according to the present disclosure may be, for example, a plug-in hybrid electric vehicle (PHEV) as long as the “vehicle” can perform the electric traveling.

The vehicle 10 further includes an electronic control unit (ECU) 16, a power control unit (PCU) 18, a navigation device 20, and a human machine interface (HMI) device 22.

The ECU 16 is a computer configured to control the vehicle 10 and corresponds to an example of the “control device for a vehicle” according to the present disclosure. The ECU 16 includes a processor 24 and a memory device 26. The processor 24 executes various processes. The various processes include processes related to control of the electric motor 14 and a calculation process of calculating a consumed energy E, which will be described below. The memory device 26 stores various types of information necessary for processing by the processor 24. When the processor 24 executes computer programs, various processes by the ECU 16 are realized. The computer programs are stored in the memory device 26. Alternatively, the computer programs may be recorded on a computer-readable recording medium. In addition, the ECU 16 may be configured by combining a plurality of ECUs.

The electric motor 14 is an alternating current (AC) electric motor as an example. The PCU 18 is a power converter including an inverter configured to drive the electric motor 14. The PCU 18 controls the electric motor 14 using the electric power of the battery 12 based on a command from the ECU 16. By the control of the PCU 18, the electric motor 14 generates a vehicle driving torque. The electric motor 14 also functions as a generator that generates regenerative torque (i.e., negative torque) by being driven by rotation of the wheels during deceleration of the vehicle 10.

The navigation device 20 includes an ECU including a processor and a memory device. The navigation device 20 is configured to be able to communicate with an external system via a wireless communication network, and can acquire various kinds of information from the external system. The various kinds of information (for example, section information) acquired by the navigation device 20 are transmitted to the ECU 16.

More specifically, the navigation device 20 acquires the current location of the vehicle 10 using a global navigation satellite system (GNSS). Further, the navigation device 20 can specify the current location of the vehicle 10 on a map by acquiring map information from an external server, for example. The map information includes road information, such as road surface gradient (more specifically, longitudinal gradient), position and curvature of a curve, and road type. The navigation device 20 can receive an operation by the user of the vehicle 10 via the HMI device 22. For example, when the user operates the HMI device 22 to input a destination, the navigation device 20 creates a planned travel route from the current location of the vehicle 10 to the destination and causes the HMI device 22 to display the planned travel route.

The navigation device 20 generates section information of the generated planned travel route based on, for example, past travel data and the map information. The navigation device 20 divides the planned travel route into a plurality of sections and generates the section information which is information of each of the plurality of divided sections. The section information includes the vehicle speed of each section (more specifically, the average vehicle speed of each section), the road surface gradient, and the road type.

### 2. Consumed Energy Calculation Process

The ECU 16 (processor 24) is configured to execute a “calculation process” of calculating a consumed energy E [kWh] of the vehicle 10. This consumed energy E corresponds to energy consumed by the electric traveling when the vehicle 10 travels in a section from a first point to a second point of the planned travel route.

To be specific, when the section information of each of a plurality of sections obtained by dividing the planned travel route as described above is acquired from the navigation device 20, the ECU 16 calculates a consumed energy Es for each section. Then, the ECU 16 calculates the sum of the calculated consumed energies Es of the respective sections as the consumed energy Et of the entire planned travel route. However, the calculation of the consumed energy E may not necessarily be performed for each of the plurality of divided sections. That is, the calculation of the consumed energy E may be performed for one section from the first point which is the current location (for example, the departure point) of the vehicle 10 to the second point which is the destination (in other words, may be performed with the entire planned travel route as one section).

An energy efficiency ne of a vehicle that can perform the electric traveling, such as the vehicle 10, varies depending on the traveling scene. More specifically, the energy efficiency ne varies depending on, for example, the type of road on which the vehicle travels. Also, the energy efficiency ne varies depending on, for example, whether the electric motor for vehicle traveling is in a powering mode or a regenerative mode. Furthermore, the energy efficiency ne varies depending on, for example, the vehicle speed. Therefore, if the fact that the energy efficiency ne differs depending on the traveling scene is not taken into consideration, in other words, if the energy efficiency ne is treated as being constant regardless of the traveling scene, an error may occur in the calculation result of the consumed energy E.

In view of the issue described above, in the present embodiment, the consumed energy E is calculated using the method of the following calculation example 1, 2, or 3.

### 2-1. Calculation Example 1 (Road Type)

In the calculation process according to the Calculation Example 1, the ECU 16 estimates whether or not the travel load of a calculation target section (also simply referred to as a “section”) of the consumed energy Es is high based on the road type of the section. Then, the ECU 16 corrects a basic value Esb of the consumed energy Es based on the energy efficiency ne (i.e., correction coefficient) that varies depending on whether or not the travel load of the section is high. To be more specific, for example, based on whether the road type of the calculation target section is an expressway or a general road, the ECU 16 estimates whether or not the travel load of the section is high.

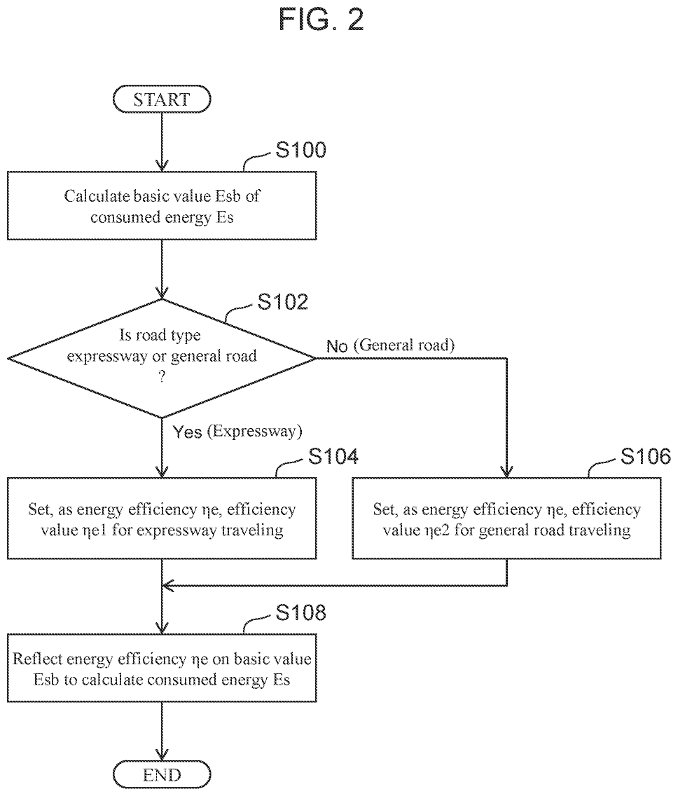

FIG. 2 is a flowchart illustrating a procedure of the calculation process according to the Calculation Example 1 of the embodiment. When the planned travel route to the destination includes a plurality of sections, the processing of this flowchart is executed for each section (that is, for each calculation target section).

In step S100, the ECU 16 calculates a basic value Esb of the consumed energy Es in the current calculation target section. The method of calculating the basic value Esb value Esb is not particularly limited, but the basic value Esb is calculated based on the section information of the current calculation target section acquired from the navigation device 20, for example. The section information includes, for example, information on the vehicle speed (for example, the average vehicle speed of the section) and road surface gradient of the calculation target section. That is, the basic value Esb is a value according to parameters, such as the vehicle speed and road surface gradient of the calculation target section.

In step S102 following step S100, the ECU 16 determines whether the road type of the current calculation target section is an expressway or a general road based on the section information from the navigation device 20. As a result, when the road type is the expressway (step S102; Yes), the processing proceeds to step S104. On the other hand, when the road type is the general road (step S102; No), the processing proceeds to step S106.

In step S104, the ECU 16 sets, as the energy efficiency ηe, an efficiency value ηe1 used when the vehicle 10 travels on the expressway. On the other hand, in step S106, the ECU 16 sets, as the energy efficiency ηe, an efficiency value ηe2 used when the vehicle 10 travels on the general road.

More specifically, according to the processing shown in FIG. 2, when the road type of the current calculation target section is the expressway, it is estimated that the travel load of the section is high. On the other hand, when the road type is the general road, it is estimated that the travel load of the section is low. What the energy efficiency ηe is high means that the consumed energy Es when the vehicle 10 travels in the same section is small. In the present embodiment, it is assumed that the energy efficiency ηe increases when the travel load is high and decreases when the travel load is low. Therefore, the efficiency value ηe1 during travel on an expressway is set to be higher than the efficiency value ηe2 during travel on a general road. For example, the efficiency value ηe1 is 0.9 (90%) and the efficiency value ηe2 is 0.75 (75%).

In addition, by repeatedly executing the processing of steps S102 to S106 for each calculation target section, the energy efficiency ηe is set for each section so as to be different depending on whether the road type of each calculation target section is the expressway or the general road.

In step S108 following step S104 or S106, the ECU 16 reflects the energy efficiency ηe (more specifically, the efficiency value ηe1 or ηe2) on the basic value Esb calculated in step S100 to calculate the consumed energy Es in the current calculation target section. More specifically, the basic value Esb basically takes a positive value. When the basic value Esb is positive, the consumed energy Es is calculated by, for example, dividing the basic value Esb by the energy efficiency ηe. On the other hand, in a section including a downhill, the basic value Esb in the section may become negative due to the effect of energy regeneration during deceleration using the electric motor 14 as a generator. When the basic value Esb is negative as described above, the consumed energy Es is calculated by, for example, multiplying the basic value Esb by the energy efficiency ηe.

As described above, according to the Calculation Example 1 illustrated in FIG. 2, whether or not the travel load of the calculation target section is high is estimated based on the road type of the calculation target section. Then, the basic value Esb of the consumed energy Es is corrected on the basis of the energy efficiency ηe (i.e., the correction coefficient) different depending on the estimation result of whether or not the travel load in the section is high. Accordingly, it is possible to accurately calculate the consumed energy Es of the section while easily estimating the level of the travel load (in other words, the energy efficiency ηe) of the calculation target section of the consumed energy Es based on the section information. In other words, the estimation accuracy of the consumed energy Es is improved.

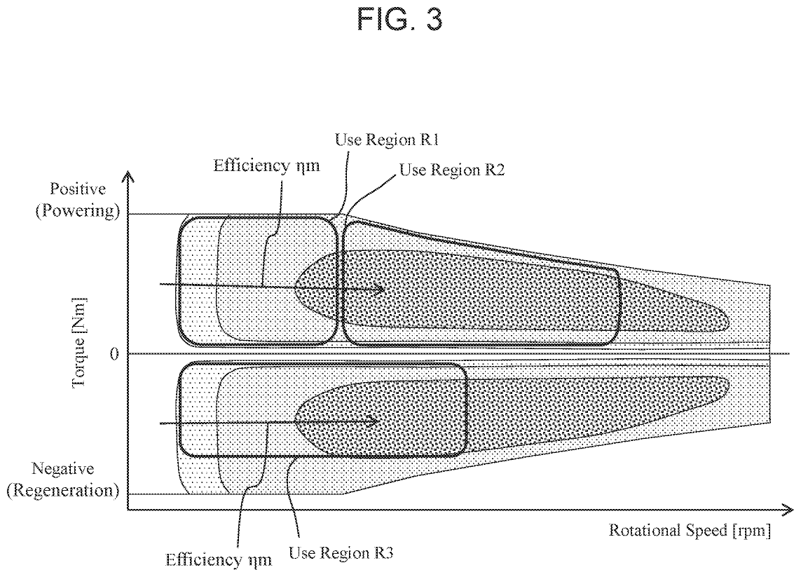

FIG. 3 is a graph showing a map (motor efficiency map) of the efficiency nm of the electric motor 14 shown in FIG. 1. In FIG. 3, the vertical axis represents the torque [Nm] of the electric motor 14, and the horizontal axis represents the rotational speed [rpm] of the electric motor 14. The efficiency nm of the electric motor 14 is expressed by the relation between the torque and the rotational speed of the electric motor 14 as shown in FIG. 3. The energy efficiency ηe is basically proportional to the efficiency nm of the electric motor 14.

Three use regions R1, R2, and R3 are represented in FIG. 3. The torque is positive in the use region R1, and the use region R1 is located on the low speed side. The torque is positive in the use region R2, and the use region R2 is located on the high speed side as compared with the use region S1. In addition, the use region R3 will be described below.

The speed of the vehicle 10 (vehicle speed) is basically proportional to the rotational speed of the electric motor 14. In other words, the rotational speed of the electric motor 14 becomes high in the high vehicle speed region. The use region R2 corresponds to a region used at the time of traveling on an expressway, and the use region R1 corresponds to a region used at the time of traveling on a general road. As shown in FIG. 3, compared with the use region R1, the use region R2 includes many regions in which the efficiency nm is high. For this reason, it is understood that a region in which the efficiency nm is high is more likely to be used at the time of traveling on an expressway than at the time of traveling on a general road. Therefore, by making the efficiency value ηe1 at the time of traveling on the expressway higher than the efficiency value ηe2 at the time of traveling on the general road as in the processing shown in FIG. 2, the energy efficiencies ηe of one or more sections included in the planned travel route can be appropriately and easily estimated in consideration of the road types of the one or more sections. Furthermore, by reflecting the energy efficiency ηe estimated in this way on the basic value Esb, the estimation accuracy of the consumed energy Es can be improved.

### 2-2. Calculation Example 2 (Powering/Regeneration)

The Calculation Example 2 is different from the Calculation Example 1 in that the magnitude (sign) of the basic value Esb of the consumed energy Es of a calculation target section is used instead of the road type of the section in order to estimate whether or not the travel load of the section is high. To be more specific, in the calculation process according to the Calculation Example 2, based on, for example, whether the basic value Esb of the calculation target section is positive or negative, the ECU 16 estimates whether or not the travel load of the section is high.

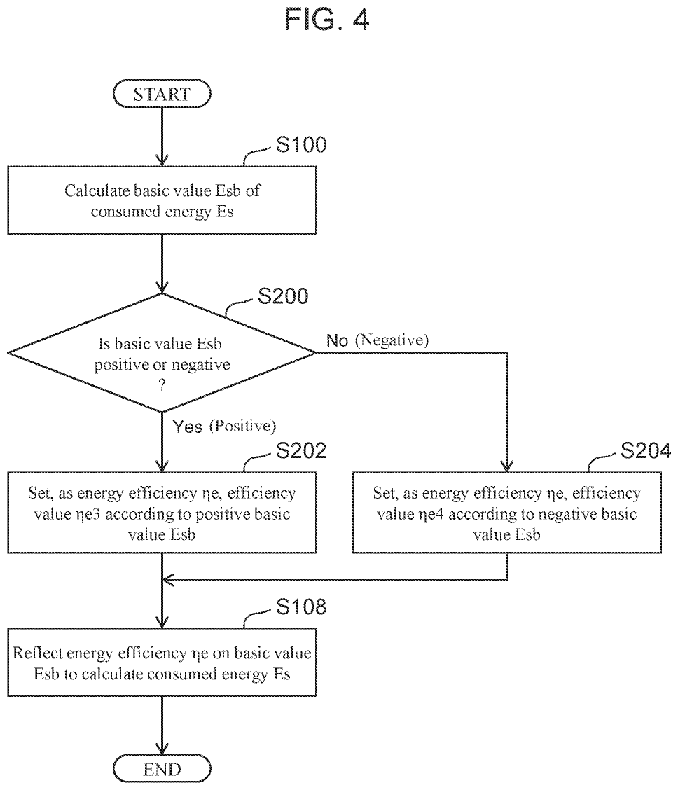

FIG. 4 is a flowchart illustrating a procedure of the calculation process according to the Calculation Example 2 of the embodiment. Differences between the processing of the flowchart shown in FIG. 2 and the processing of this flowchart will be described below.

In FIG. 4, the processing proceeds to step S200 after step S100. In step S200, the ECU 16 determines whether the basic value Esb calculated in step S100 is positive or negative. As a result, when the basic value Esb is positive (step S200; Yes), the processing proceeds to step S202. On the other hand, when the basic value Esb is negative (step S200; No), the processing proceeds to step S204.

In step S202, the ECU 16 sets, as the energy efficiency ηe, an energy efficiency value ηe3 used when the basic value Esb is positive. Thereafter, the processing proceeds to step S108. On the other hand, in step S204, the ECU 16 sets, as the energy efficiency ηe, an efficiency value ηe4 used when the basic value Esb is negative. Thereafter, the processing proceeds to step S108.

More specifically, according to the processing shown in FIG. 4, when the basic value Esb of the current calculation target section is positive, it is estimated that the travel load of the section is high. On the other hand, when the basic value Esb is negative, it is estimated that the travel load of the section is low. Accordingly, the efficiency value ηe3 used when the basic value Esb is positive is set to be higher than the efficiency value ηe4 used when the basic value Esb is negative. For example, the efficiency value ηe3 is 0.9 (90%) and the efficiency value ηe4 is 0.75 (75%).

In addition, the section in which the basic value Esb is positive corresponds to a section in which the influence of the energy consumption by the electric motor 14 in the powering mode on the basic value Esb is greater than the influence of the energy regeneration by the electric motor 14 in the regenerative mode on the basic value Esb, or a section in which the electric motor 14 is used only in the powering mode. Conversely, the section in which the basic value Esb is negative corresponds to a section in which the influence of energy regeneration by the electric motor 14 in the regenerative mode on the basic value Esb is greater than the influence of energy consumption by the electric motor 14 in the powering mode on the basic value Esb, or a section in which the electric motor 14 is used only in the regenerative mode.

As described above, according to the Calculation Example 2 illustrated in FIG. 4, it is estimated whether or not the travel load of the calculation target section is high, based on the magnitude (sign) of the basic value Esb of the consumed energy Es in the calculation target section. Even with this method, it is possible to accurately calculate the consumed energy Es of the section while easily estimating the level of the travel load (in other words, the energy efficiency ηe) of the calculation target section of the consumed energy Es based on the section information.

In the use region R3 in FIG. 3, the torque of the electric motor 14 is negative, and this use region R3 is located on the low speed side. Also, this use region R3 is used when the electric motor 14 is in the regenerative mode. On the other hand, when the electric motor 14 is in the powering mode, the use regions R1 and R2 are used. It can be seen from FIG. 3 that the ratio of the high efficiency region (i.e., region in which the efficiency nm is high) to the entire use regions R1 and R2 during the powering mode is higher than the ratio of the high efficiency region to the entire use region R3 during the regenerative mode. Also, the electric motor 14 is the regenerative mode during deceleration of the vehicle 10. Therefore, when the electric traveling in a section is considered on average, it can be said that the vehicle speed during the regenerative mode is lower than that during the powering mode. From these facts, it can be seen that when the basic value Esb is positive, a region in which the efficiency nm is high is more likely to be used than when the basic value Esb is negative. Therefore, by making the efficiency value ηe3 used when the basic value Esb is positive higher than the efficiency value ηe4 used when the basic value Esb is negative as in the processing shown in FIG. 4, the energy efficiencies ηe of one or more sections included in the planned travel route can be appropriately and easily estimated in consideration of the magnitude (sign) of the basic values Esb of the one or more sections. Furthermore, by reflecting the energy efficiency ηe estimated in this way, the estimation accuracy of the consumed energy Es can be improved.

### 2-3. Calculation Example 3 (Vehicle Speed)

The Calculation Example 3 is different from the Calculation Example 1 in that the vehicle speed of a calculation target section is used instead of the road type of the section in order to estimate whether or not the travel load of the section is high. To be more specific, in the calculation process according to the Calculation Example 3, the ECU 16 estimates whether or not the travel load of the calculation target section is high, based on whether or not the vehicle speed of the calculation target section is equal to or higher than a threshold value.

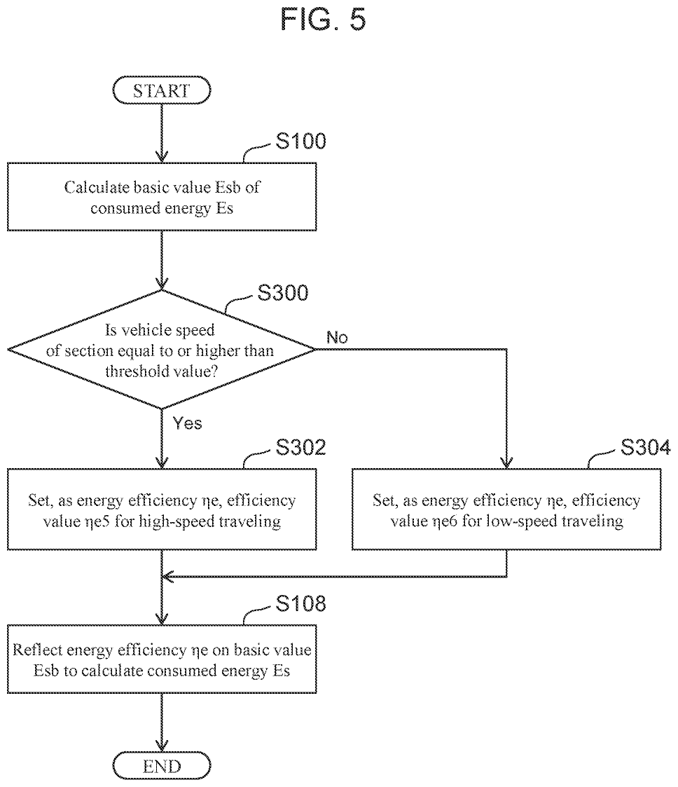

FIG. 5 is a flowchart illustrating a procedure of the calculation process according to the Calculation Example 3 of the embodiment. Differences between the processing of the flowchart shown in FIG. 2 and the processing of this flowchart will be described below.

In FIG. 5, the processing proceeds to step S300 after step S100. In step S300, the ECU 16 determines whether or not the vehicle speed of the current calculation target section (for example, the average vehicle speed of the section) is equal to or higher than a designated threshold value (for example, 80 km/h), based on the section information from the navigation device 20. As a result, when the vehicle speed of the section is equal to or higher than the threshold value (step S300; Yes), the processing proceeds to step S302. On the other hand, when the vehicle speed of the section is lower than the threshold value (step S300; No), the processing proceeds to step S304.

In step S302, the ECU 16 sets, as the energy efficiency ηe, an efficiency value ηe5 used when the vehicle speed of the section is equal to or higher than the threshold value (i.e., an efficiency value ηe5 used during high speed traveling). Thereafter, the processing proceeds to step S108. On the other hand, in step S304, the ECU 16 sets, as the energy efficiency ηe, an efficiency value ηe6 used when the vehicle speed of the section is lower than the threshold value (i.e., an efficiency value ηe6 used during low speed traveling). Thereafter, the processing proceeds to step S108.

More specifically, when the vehicle speed of the current calculation target section is equal to or higher than the threshold value, it is estimated that the travel load of the section is high. On the other hand, when the vehicle speed of the section is lower than the threshold value, it is estimated that the travel load of the section is low. Accordingly, the efficiency value ηe5 used during high speed traveling is set to be higher than the efficiency value ηe6 used during low speed traveling. For example, the efficiency value ηe5 is 0.9 (90%) and the efficiency value ηe6 is 0.75 (75%).

As described above, according to the Calculation Example 3 shown in FIG. 4, based on the vehicle speed of the calculation target section, it is estimated whether or not the travel load of the section is high. Even with this method, it is possible to accurately calculate the consumed energy Es of the section while easily estimating the level of the travel load (in other words, the energy efficiency ηe) of the calculation target section of the consumed energy Es based on the section information.

In addition, as can be seen from the description already given for the Calculation Example 1 with reference to FIG. 3, a region in which the efficiency nm is high is more likely to be used at the time of high speed traveling than at the time of low speed traveling. Therefore, by making the efficiency value ηe5 at the time of high speed traveling higher than the efficiency value ηe6 at the time of low speed traveling as in the processing shown in FIG. 5, the energy efficiencies ηe of one or more sections included in the planned travel route can be appropriately and easily estimated in consideration of the vehicle speeds of the one or more sections. Furthermore, by reflecting the energy efficiency ηe estimated in this way on the basic value Esb, the estimation accuracy of the consumed energy Es can be improved.

1. A control device for controlling a vehicle configured to perform an electric traveling using one or more electric motors driven by electric power from a battery, the control device comprising a processor configured to execute a calculation process of calculating an energy consumed by the electric traveling in a section from a first point to a second point of a planned travel route of the vehicle, wherein
in the calculation process, the processor is configured to:
estimate whether or not a travel load of the section is high, based on road type of the section; and
correct a basic value of the energy consumed, based on a correction efficient that differs depending on whether or not the travel load of the section is high.

2. The control device according to claim 1, wherein
in the calculation process, the processor is configured to estimate whether or not the travel load of the section is high, based on whether the road type of the section is an expressway or a general road.

3. A control device for controlling a vehicle configured to perform an electric traveling using one or more electric motors driven by electric power from a battery, the control device comprising a processor configured to execute a calculation process of calculating an energy consumed by the electric traveling in a section from a first point to a second point of a planned travel route of the vehicle, wherein
in the calculation process, the processor is configured to:
estimate whether or not a travel load of the section is high, based on magnitude of a basic value of the energy consumed in the section; and
correct the basic value, based on a correction efficient that differs depending on whether or not the travel load of the section is high.

4. The control device according to claim 3, wherein
in the calculation process, the processor is configured to estimate whether or not the travel load of the section is high, based on whether the basic value of the section is positive or negative.

5. A control device for controlling a vehicle configured to perform an electric traveling using one or more electric motors driven by electric power from a battery, the control device comprising a processor configured to execute a calculation process of calculating an energy consumed by the electric traveling in a section from a first point to a second point of a planned travel route of the vehicle, wherein
in the calculation process, the processor is configured to:
estimate whether or not a travel load of the section is high, based on vehicle peed of the section; and
correct a basic value, based on a correction efficient that differs depending on whether or not the travel load of the section is high.
